(19) United States
(12) Patent Application Publication
(10) Pub. No.: US 2013/0284350 A1
(43) Pub. Date: Oct. 31, 2013

(54) MANUFACTURING METHOD OF LIQUID CRYSTAL DISPLAY DEVICE

(71) Applicant: JAPAN DISPLAY EAST INC., Mobara-shi (JP)

(72) Inventors: Akira ISHII, Mobara-shi (JP); Setsuo KOBAYASHI, Mobara-shi (JP); Katsuhiko ISHII, Chosei (JP); Kiyoshi SENTO, Sakura-shi (JP)

(73) Assignee: JAPAN DISPLAY EAST INC., Mobara-shi (JP)

(21) Appl. No.: 13/834,902

(22) Filed: Mar. 15, 2013

(30) Foreign Application Priority Data
Apr. 27, 2012 (JP) 2012-102909

(51) Int. Cl. B29D 11/00

(52) U.S. Cl. CPC B29D 11/0073
USPC 156/146

(57) ABSTRACT

An ultraviolet-curable resin is formed over a touch panel, and a liquid crystal display panel is bonded to the touch panel. Subsequently, an ultraviolet-curable resin is formed over the touch panel, and a front window is bonded to the touch panel. While the ultraviolet-curable resin is cured unevenly due to a black-frame print made around the periphery of the front window, the touch panel and the counter substrate of the liquid crystal display panel are already bonded together at this time. This prevents the uneven cure of the ultraviolet-curable resin from distorting the counter substrate alone. As a result, it is possible to avoid unevenness of the gap between the counter substrate and the TFT substrate of the liquid crystal display panel and the resulting yellowing around the periphery.

### CLAIM OF PRIORITY

The present application claims priority from Japanese Patent Application JP 2012-102909 filed on Apr. 27, 2012, the content of which is hereby incorporated by reference into this application.

### BACKGROUND

The present invention relates to a liquid crystal display device and in particular to a display device including a touch panel and a front window (a cover glass for example).

A liquid crystal display panel included in a liquid crystal display device includes a TFT substrate (a first substrate), a counter substrate (a second substrate) disposed so as to be opposed to the TFT substrate, and liquid crystal interposed between the TFT substrate and the counter substrate. The TFT substrate has pixel electrodes, thin-film transistors (TFTs), and the like formed thereover in a matrix. The counter substrate has color filters and the like disposed in positions corresponding to the pixel electrodes of the TFT substrate thereover. The liquid crystal display device forms images by controlling the transmittance of light using liquid crystal molecules for each pixel.

Liquid crystal display devices are strongly required to reduce external dimensions of the set while keeping their screen size constant, as well as to thin their liquid crystal display panel. For this reason, liquid crystal display panels are thinned by polishing the outside thereof.

The thicknesses of the glass substrates included in both the TFT substrate and the counter substrate are standardized to, for example, 0.5 mm or 0.7 mm. Glass substrates other than these standardized glass substrates are not available from the market. Further, extremely thin glass substrates pose a problem, such as insufficient mechanical strength or deflection, in the manufacturing process, thereby reducing manufacturing yield. Accordingly, liquid crystal display panels are formed using a standardized glass substrate and then thinned by polishing the external surface thereof.

Thinning a liquid crystal display panel poses a mechanical strength problem. Application of mechanical pressure to the display surface of the liquid crystal display panel may cause breakage of the liquid crystal display panel. To prevent such breakage, a front window (a third substrate) is mounted over the screen of the liquid crystal display panel when incorporating the liquid crystal display panel into a set, such as a mobile phone.

Typically, an ultraviolet-curable resin is used to mount a front window over a liquid crystal display panel. Meanwhile, a black-frame print is made around the periphery of the front window for an increase in designability or image quality or other purposes. The black-frame printed portion does not easily transmit ultraviolet rays, thereby causing uneven cure of the ultraviolet-curable resin.

Japanese Unexamined Patent Application Publication No. 2009-192792 discloses a method of making gradations in making a black-frame print and then curing the ultraviolet-curable resin below the black-frame print, so as to prevent uneven cure of the ultraviolet-curable resin due to the black-frame print. Specifically, Japanese Unexamined Patent Application Publication No. 2009-192792 discloses a configuration which makes a black-frame print over an inner region lightly and over an outer region densely so as to prevent cure of the resin from causing stress in the substrate.

On the other hand, to make liquid crystal display devices easy to use, many liquid crystal display devices including a touch panel have been used. A touch panel is disposed between the counter substrate of the liquid crystal display panel and the front window and bonded to the counter substrate or the front window using an adhesive. Japanese Unexamined Patent Application Publication No. 2010-091868 discloses a configuration which specifies an adhesive formation range to improve the adhesiveness between the touch panel and the front window or to prevent inclusion of bubbles when pressing the touch panel and front window using a roller.

### SUMMARY

However, it is found that the technology disclosed in Japanese Unexamined Patent Application Publication No. 2009-192792 does not necessarily reduce stress caused in the glass substrate and rather may promote uneven cure of the ultraviolet-curable resin. Further, while a black-frame print is made to increase display quality, the inner region having the black-frame print made lightly thereover disadvantageously makes the screen loose.

If stress is applied unevenly when bonding a liquid crystal display panel, a touch panel, and a front window together using an adhesive, the counter substrate of the liquid crystal display panel becomes deformed. This makes changes to the thickness of the liquid crystal layer, causing color irregularities or the like. Unfortunately, Japanese Unexamined Patent Application Publication No. 2010-091868 includes no description about this problem.

If the counter substrate or TFT substrate which is made of glass has a large thickness in the liquid crystal display panel, no problem occurs even when these substrates become deformed. This is because these substrates have high strength. However, there is a requirement to reduce the thickness of the TFT substrate or counter substrate to about 0.2 mm or 0.15 mm to thin the liquid crystal display device. If such a requirement is met to thin the substrate, deformation of the substrate makes changes to the thickness of the liquid crystal layer, causing color irregularities or the like.

Such deformation of the substrate is less likely to occur in a liquid crystal display panel formed by injecting liquid crystal under vacuum, as shown in FIGS. 23A and 23B. In FIG. 23A, liquid crystal 60 which has been injected under vacuum is partially extracted by external force F, and the gap between a flat TFT substrate 10 and a flat counter substrate 20 which are bonded together using a sealant 15 is completely filled with the liquid crystal 60. Subsequently, as shown in FIG. 23B, an inlet for the liquid crystal 60 is sealed using a sealant 16. Both steps of FIGS. 23A and 23B are performed under atmospheric pressure. For this reason, as shown in FIG. 23B, the TFT substrate 10 and the counter substrate 20 have an inwardly protruding shape. As seen above, the inwardly protruding TFT substrate 10 and counter substrate 20 are less likely to suffer deformation which may change the thickness of the liquid crystal layer.

On the other hand, methods for injecting (filling) the liquid crystal 60 include one drop fill (ODF). In this method, as shown in FIG. 24A, a precisely controlled amount of liquid crystal 70 is dropped inside the sealant 15 formed over the counter substrate 20, and subsequently the TFT substrate 10 and the counter substrate 20 are bonded together. The gap is filled with liquid crystal more quickly by ODF than by vacuum injection. On the other hand, as shown in FIG. 24B, the TFT substrate 10 and the counter substrate 20 are flat, not inwardly protruding. Such flat substrates tend to become deformed by external force.

In a liquid crystal display device provided with a touch panel and a front window, the counter substrate of the liquid crystal display panel is particularly susceptible to stress. An advantage of the present invention is to provide a manufacturing method of a liquid crystal display device that includes a liquid crystal display panel formed by ODF and including a counter substrate having a thickness within a predetermined range and which prevents deformation of the counter substrate and the resulting color irregularities.

An aspect of the present invention provides a manufacturing method of a liquid crystal display device, the liquid crystal display device including a liquid crystal display panel, a touch panel, and a front window (a third substrate), the liquid crystal display panel being a liquid crystal display panel where a thin-film transistor (TFT) substrate (a first substrate) having pixels each including a pixel electrode and a TFT formed thereover and a counter substrate (a second substrate) having color filters formed thereover are bonded together using a sealant; liquid crystal is sealed; a lower polarizing plate is bonded to the TFT substrate; and an upper polarizing plate is bonded to the counter substrate, the liquid crystal being injected into the liquid crystal display panel by one drop fill, the counter substrate being smaller in thickness than the touch panel, and the front window being larger in thickness than the touch panel. The method includes: bonding the upper polarizing plate of the liquid crystal display panel and the touch panel together using an ultraviolet-curable resin by applying ultraviolet rays to the ultraviolet curable resin from a side adjacent to the touch panel; and after the above step, bonding the touch panel and the front window together using an ultraviolet-curable resin by applying ultraviolet rays to the ultraviolet curable resin from a side adjacent to the front window.

Another aspect of the present invention provides a manufacturing method of, in bonding together a liquid crystal display panel formed by injecting liquid crystal by one drop fill (ODF), a touch panel, and a front window using an adhesive sheet in place of the ultraviolet curable resin, first bonding the liquid crystal display panel and the touch panel together and then bonding the front window and the touch panel together.

According to the present invention, in a liquid crystal display device formed by bonding a touch panel and a front window to a liquid crystal display panel including thin substrates and manufactured by using ODF, it is possible to prevent deformation of the counter substrate of the liquid crystal display panel and thus prevent a change in the thickness of the liquid crystal layer and the resulting color irregularities in the thickness-changed portion.

### BRIEF DESCRIPTION OF THE DRAWINGS

FIG. 1 is a plan view of a liquid crystal display device to which the present invention is applied;

FIG. 2 is a sectional view taken along line A-A of FIG. 1;

FIG. 3 is an enlarged view of a portion D of FIG. 2;

FIG. 4 is a sectional view in which an ultraviolet-curable resin is disposed below a touch panel;

FIG. 5 is a sectional view showing a state in which a touch panel is bonded to a liquid crystal display panel using an ultraviolet-curable resin;

FIG. 6 is a sectional view in which an ultraviolet-curable resin is disposed over the touch panel bonded with the liquid crystal display panel;

FIG. 7 is a sectional view in which a front window is bonded to the touch panel bonded with the liquid crystal display panel, using an ultraviolet-curable resin;

FIG. 8 is a flowchart showing a manufacturing process of a liquid crystal display device according to the present invention;

FIG. 9 is a plan view of a liquid crystal display device according to the related art;

FIG. 10 is a sectional view in which an ultraviolet-curable resin is disposed below a front window;

FIG. 11 is a sectional view showing a state in which a touch panel is bonded to the front window using the ultraviolet-curable resin;

FIG. 12 is a sectional view in which an ultraviolet-curable resin is disposed below the touch panel bonded with the front window;

FIG. 13 is a related-art sectional view showing a state in which a liquid crystal display panel is bonded to the touch panel bonded with the front window, using the ultraviolet-curable resin;

FIG. 14 is a flowchart showing a manufacturing process of a liquid crystal display device according to the related art;

FIG. 15 is a sectional view in which an adhesive sheet is disposed below a touch panel;

FIG. 16 is a sectional view in which the touch panel and a liquid crystal display panel are bonded together using the adhesive sheet;

FIG. 17 is a sectional view in which an adhesive sheet is disposed over the touch panel bonded with the liquid crystal display panel;

FIG. 18 is a sectional view in which a front window is bonded to the touch panel bonded with the liquid crystal display panel, using the adhesive sheet;

FIG. 19 is a sectional view in which an adhesive sheet is disposed below a front window;

FIG. 20 is a sectional view in which a touch panel is bonded to the front window using an adhesive sheet;

FIG. 21 is a sectional view in which a liquid crystal display panel is bonded to the touch panel bonded with the front window, using an adhesive sheet;

FIG. 22 is a plan view showing a problem with the related art;

FIGS. 23A and 23B are sectional views of a liquid crystal display panel which is filled with liquid crystal injected by vacuum injection; and

FIG. 24A is a plan view of a liquid crystal display panel which is filled with liquid crystal injected by ODF, and FIG. 24B is a sectional view of the liquid crystal display panel.

### DESCRIPTION OF THE PREFERRED EMBODIMENTS

Before describing embodiments of the present invention, problems associated with liquid crystal display devices to which the present invention is to be applied will be described. FIG. 9 is a plan view of a liquid crystal display device for use in mobile phones and the like. In FIG. 9, a front window 40 is disposed over the front surface. A black-frame print 41 is made around the periphery of the front window 40, and a display region 100 is disposed inside the black-frame print 41. A touch panel and a liquid crystal display panel below the front window 40 are smaller than the front window 40 and therefore are not shown in FIG. 9. In a left portion of FIG. 9, there extends a flexible wiring board 80 and a flexible wiring board 85 for backlight which are connected to the liquid crystal display panel.

In FIG. 9, there is a yellowed region 110 around the periphery of the display region 100, that is, inside the region having the black-frame print 41 made thereover. As will be discussed later, the reason why the yellowed region 110 is formed is that the gap between a TFT substrate 10 and a counter substrate 20 is larger than a predetermined gap in the liquid crystal display panel.

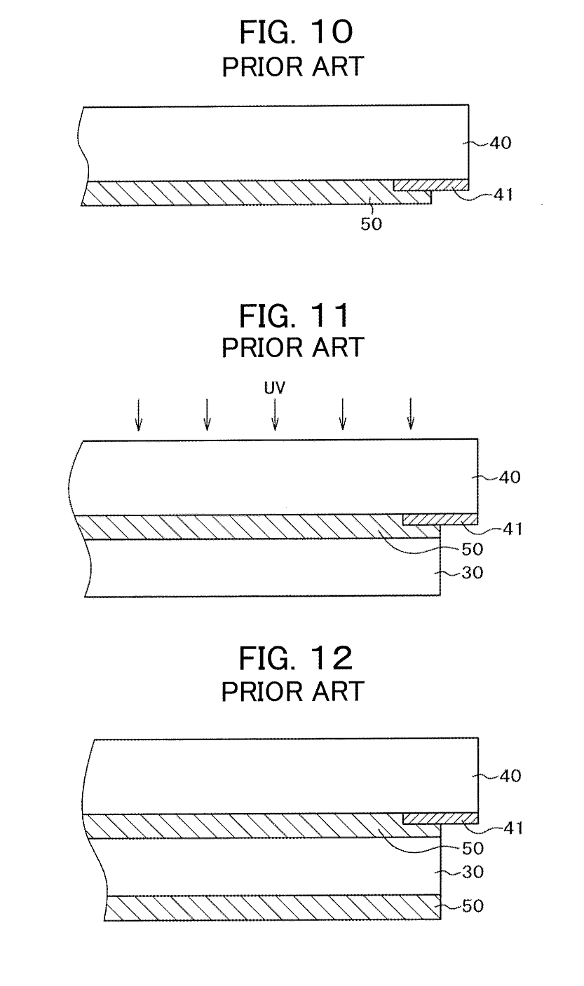

FIGS. 10 to 13 are diagrams showing a liquid crystal display device manufacturing process according to the related art. FIG. 10 is a sectional view showing a state in which an adhesive 50 made of an ultraviolet-curable resin is formed below the bottom surface of the front window 40. The black-frame print 41 is made around the periphery of the front window 40. FIG. 11 shows a state in which a touch panel 30 is bonded to the adhesive 50 over the front window 40. The adhesive 50, which is made of an ultraviolet-curable resin, is cured by applying ultraviolet rays UV to the adhesive 50 from the side adjacent to the front window 40.

At this time, the curing time or curing state of the adhesive 50 varies between regions due to the black-frame print 41 made around the periphery of the front window 40. That is, the curing time or curing state of the adhesive 50 varies between the region below the black-frame print 41 and the other region. Thus, stress is applied to the touch panel 30. However, the touch panel 30 is as thick as about 0.2 to 0.5 mm and therefore does not become deformed easily. Even if the touch panel 30 becomes deformed, it has almost no optical effect.

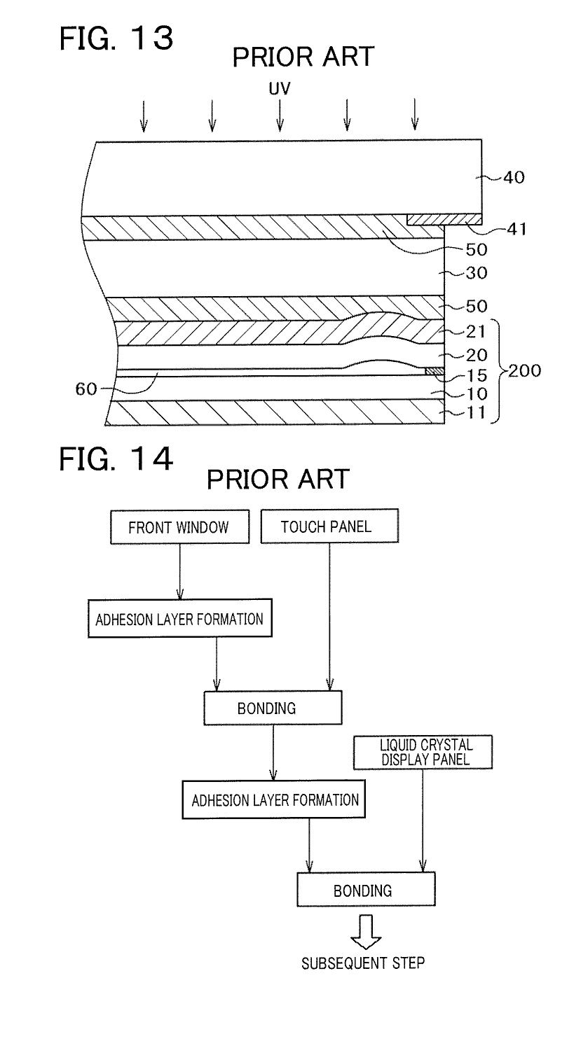

FIG. 12 shows a state in which the adhesive 50 made of an ultraviolet-curable resin is applied to the touch panel 30 bonded to the front window 40 as described above. FIG. 13 shows a state after bonding a liquid crystal display panel 200 to the touch panel 30 and then applying ultraviolet rays UV to the adhesive 50 to cure the adhesive 50. The liquid crystal display panel 200 is a liquid crystal display device where liquid crystal 60 is interposed between the TFT substrate 10 and the counter substrate 20; a lower polarizing plate 11 is bonded to the bottom of the TFT substrate 10; and an upper polarizing plate 21 is bonded to the top of the counter substrate 20.

Ultraviolet rays are applied to the adhesive 50 from the side adjacent to the front window 40. This is because the liquid crystal display panel 200 includes the polarizing plates and therefore ultraviolet rays applied from the side adjacent to the liquid crystal display panel 200 would not sufficiently reach the adhesive 50.

In FIG. 13, the TFT substrate 10 and the counter substrate 20 are 0.15 to 0.2 mm thick, that is, very thin. Accordingly, these substrates become easily deformed by stress. The polarizing plates are 0.1 to 0.13 mm thick, that is, very thin, as well as made of a resin. Accordingly, these polarizing plates become deformed easily. Accordingly, in FIG. 13, ultraviolet rays are applied to the adhesive 50 from the side adjacent to the front window 40. For the adhesive 50 formed between the touch panel 30 and the upper polarizing plate 21 of the liquid crystal display panel 200 and made of an ultraviolet-curable resin, the curing time or curing state varies between regions thereof due to the black-frame print 41 made below the front window 40. That is, the curing time or curing state varies between the region below the black-frame print 41 and the other region.

The variation in curing time or curing state causes stress between the touch panel 30, and the upper polarizing plate 21 and the counter substrate 20 of the liquid crystal display panel 200. Since the touch panel 30 is thicker and more rigid, deformation occurs in the upper polarizing plate 21 and the counter substrate 20 of the liquid crystal display panel 200. The stress attributable to the curing state of the resin occurs in the portion corresponding to around the edge of the black-frame print 41 below the front window 40. This stress acts as a force pulling up the counter substrate 20. The resulting distortion widens the liquid crystal 60. Thus, colors are shifted to longer wavelengths in the widened region, causing a so-called yellowing phenomenon. This results in the yellowed region around the display region shown in FIG. 9. The amount of distortion that actually occurs in the counter substrate is as small as about 0.4 μm. In an in-plane-switching (IPS) liquid crystal display device, however, the gap between the TFT substrate 10 and the counter substrate 20 is about 4 μm and therefore the 0.4-μm gap variation has a significant effect on optical properties.

FIG. 14 is a flowchart showing the manufacturing process of the liquid crystal display device described with respect to FIGS. 10 to 13. In FIG. 14, the adhesive 50 is formed below the front window 40 having the black-frame print 41 made therebelow; the separately prepared touch panel 30 is bonded to the front window 40; and the adhesive 50 is cured by ultraviolet irradiation. Subsequently, the adhesive 50 is formed below the touch panel 30; the separated prepared liquid crystal display panel 200 is bonded to the touch panel 30; and the adhesive 50 is cured by applying ultraviolet rays to the adhesive 50 from the side adjacent to the front window 40.

At this time, the adhesive 50 is cured unevenly due to the black-frame print 41 formed below the front window 40. Thus, distortion occurs in the upper polarizing plate 21 and the counter substrate 20 of the liquid crystal display panel 200. This results in yellowing around the display region in the related art. Yellowing occurs due to thickening of the liquid crystal layer 60 around the distorted portion of the counter substrate 20. Accordingly, it is required to prevent deformation of the counter substrate 20. While the problems associated with the related art have been described, the sizes of the front window 40, the touch panel 30, and the liquid crystal display panel 200 are not limited to those described above.

The present invention is intended to suppress such deformation of the counter substrate 20 to prevent color irregularities, such as yellowing, around the display region of the liquid crystal display device.

### First Embodiment

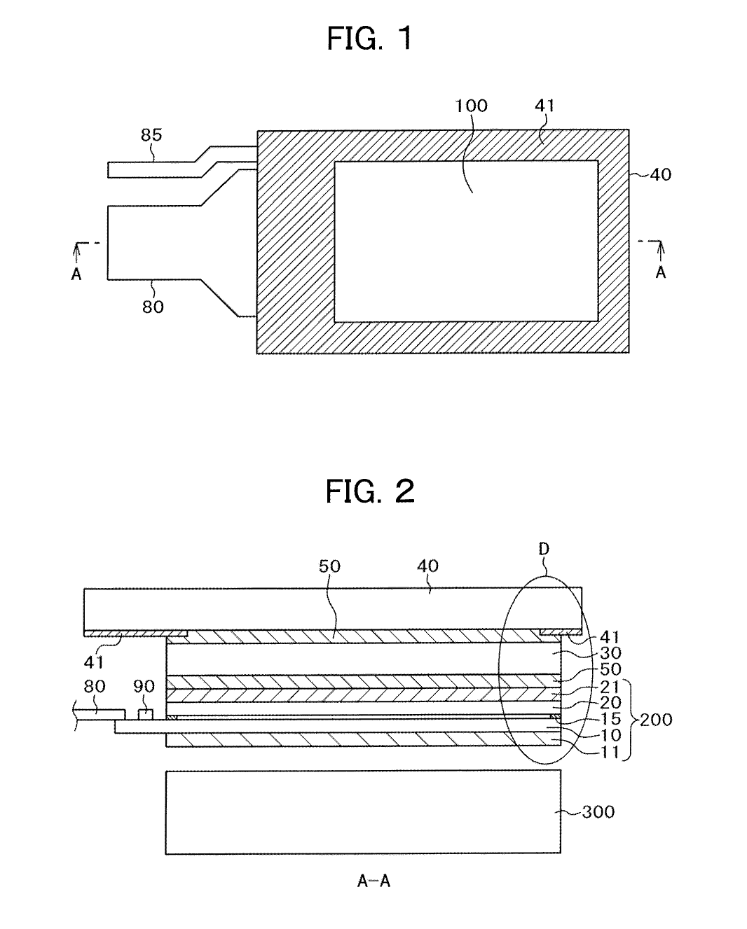

FIG. 1 is a plan view of a liquid crystal display device according to a first embodiment. In FIG. 1, the front window 40 (a third substrate) is disposed over the front surface. The black-frame print 41 is made around the periphery of the front window 40, and the display region 100 is disposed inside the black-frame print 41. In a left portion of FIG. 1, there extends a flexible wiring board 80 and a flexible wiring board 85 for backlight which are connected to the liquid crystal display panel disposed below the front window.

In FIG. 1, there is no yellowed region around the display region 100, that is, inside the black-frame print 41, unlike in FIG. 9. The reason is that in the present embodiment, as will be discussed later, stress is relaxed which is caused by the ultraviolet-curable resin bonding the touch panel 30 and the liquid crystal display panel 200 together, thereby preventing deformation of the counter substrate in the liquid crystal display panel.

FIG. 2 is a sectional view taken along line A-A of FIG. 1. In FIG. 2, the liquid crystal display panel 200 having the front window 40 and the touch panel 30 bonded thereto is disposed over a backlight 300. The backlight 300 has a configuration in which an LED serving as a light source, a light guide plate, a reflection sheet, a diffusion sheet, a prism sheet, and the like are contained in, for example, a resin mold. The liquid crystal display panel 200 is placed over the resin mold.

In FIG. 2, the liquid crystal display panel 200 includes the TFT substrate 10 (a first substrate), the counter substrate 20 (a second substrate), the lower polarizing plate 11, and the upper polarizing plate 21. The liquid crystal 60 is interposed between the TFT substrate 10 and the counter substrate 20 and sealed by a sealant 15. While the TFT substrate 10 and the counter substrate 20 are originally 0.5 mm thick, their thickness is reduced to about 0.2 mm by polishing.

The liquid crystal 60 is injected by one drop fill (ODF). That is, the sealant 15 is formed below the counter substrate 20, the liquid crystal 60 is dropped below the counter substrate 20 by ODF, and subsequently the TFT substrate 10 is bonded to the counter substrate 20. The TFT substrate 10 is formed so as to be larger than the counter substrate 20; an IC driver 90 is mounted over the singly disposed portion of the TFT substrate 10; and the flexible wiring board 80 is connected to that portion.

The touch panel 30 is bonded to the upper polarizing plate 21 bonded to the counter substrate 20, using the adhesive 50 which is made of an ultraviolet-curable resin. The front window 40 is bonded to the touch panel 30 using the adhesive 50 which is made of an ultraviolet-curable resin. The black-frame print 41 is made around the periphery of the front window 40.

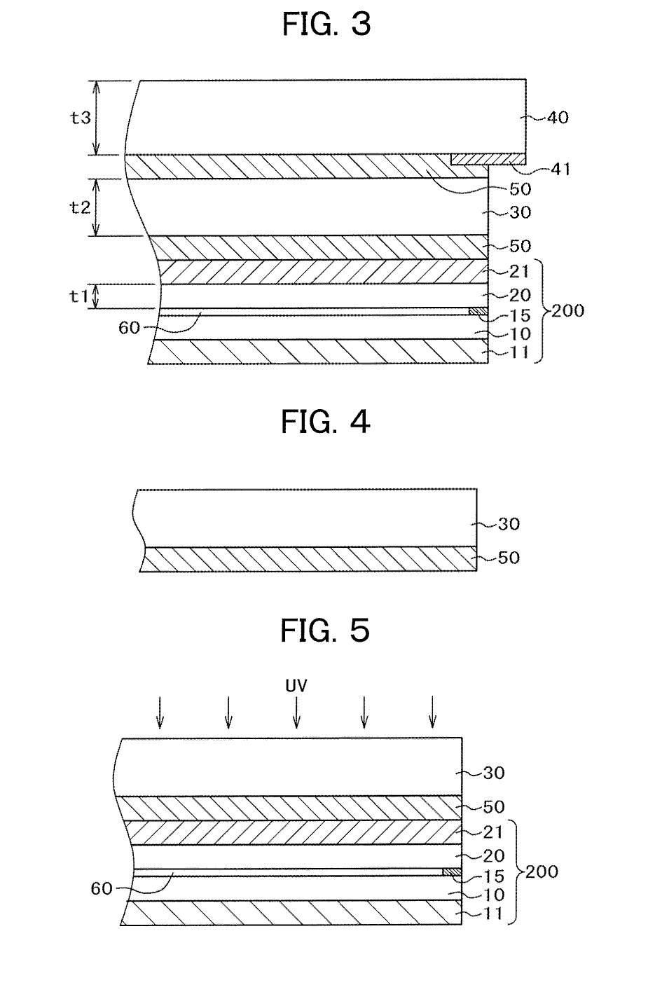

FIG. 3 is an enlarged view of a portion D of FIG. 2. In FIG. 3, the liquid crystal layer 60 is interposed between the TFT substrate 10 and the counter substrate 20 in the liquid crystal display panel 200. The respective peripheries of the TFT substrate 10 and the counter substrate 20 are bonded together using the sealant 15. In FIG. 3, the thickness t1 of the counter substrate 20 of the liquid crystal display panel 200 is 0.15 to 0.2 mm; the thickness t2 of the touch panel 30 is 0.2 to 0.5 mm; and the thickness of the front window 40 is 0.5 to 1.2 mm. As seen above, the counter substrate 20 of the liquid crystal display panel 200 is the thinnest and therefore easily becomes deformed. While the TFT substrate 10 and the counter substrate 20 have the same thickness in the present embodiment, the present invention is also applicable to cases where they have different thicknesses.

In FIG. 3, although the black-frame print 41 is made around the periphery of the front window 40, the cure of the adhesive 50 which is bonding the touch panel 30 and the liquid crystal display panel 200 together has no effect on the counter substrate 20 of the liquid crystal display panel 200. That is, deformation does not occur in the counter substrate 20 of the liquid crystal display panel 200, unlike in FIG. 13. Accordingly, yellowing would not occur around the periphery of the display region.

FIGS. 4 to 7 show such a manufacturing process, in which distortion does not occur in the counter substrate 20 of the liquid crystal display panel 200. First, in FIG. 4, the adhesive 50 made of an ultraviolet-curable resin is formed below the touch panel 30. Examples of the ultraviolet-curable resin include SVR1100, SVR1320, and SVR1240H available from Dexerials Corporation.

In FIG. 5, the liquid crystal display panel 200 is bonded to the touch panel 30, and ultraviolet rays are applied to the adhesive 50 from the side adjacent to the touch panel 30 to cure the adhesive 50. Since lines having a width of about 0.1 mm are simply formed in the touch panel 30 in an almost uniform manner, ultraviolet rays are applied to the adhesive 50 uniformly, preventing the resin from being cured unevenly. Accordingly, no stress is applied to the counter substrate 20 of the liquid crystal display panel 200, preventing distortion of the counter substrate 20. As a result, the gap between the TFT substrate 10 and the counter substrate 20 is kept uniform.

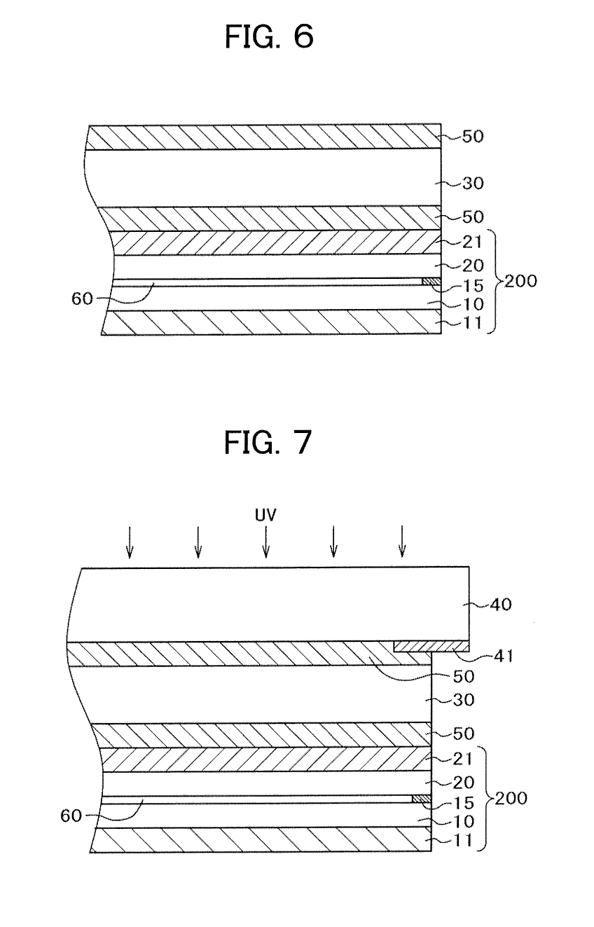

In FIG. 6, the adhesive 50 made of an ultraviolet-curable resin is formed over the touch panel 30 bonded with the liquid crystal display panel 200. In FIG. 7, the front window 40 is disposed over the touch panel 30 bonded with the liquid crystal display panel 200 with the adhesive 50 therebetween, and ultraviolet rays are applied to the adhesive 50 from the side adjacent to the front window 40.

In FIG. 7, the black-frame print 41 is made around the periphery of the front window 40. The curing time of the adhesive 50 varies between the portion thereof below the black-frame print 41 and the other portion thereof. Accordingly, distortion occurs between the adhesive 50, and front window 40 or touch panel 30. However, the touch panel 30 and the liquid crystal display panel 200 are already bonded together at this time, and the mechanical strength is a combined strength of the touch panel 30 and the liquid crystal display panel 200. Accordingly, the touch panel 30 does not become easily distorted.

Further, even if distortion occurs in the touch panel 30, the distortion does not affect the gap between the TFT substrate 10 and the counter substrate 20 of the liquid crystal display panel 200. This is because the touch panel 30 and the liquid crystal display panel 200 are already bonded together. Thus, yellowing would not occur around the periphery of the display region. Further, even if distortion occurs in the touch panel 30, the distortion would have no effect on the optical properties of the liquid crystal display device.

As seen above, in the present invention, the liquid crystal display panel 200 and the touch panel 30 are first bonded together using the adhesive 50. This can prevent the gap between the TFT substrate 10 and the counter substrate 20 of the liquid crystal display panel 200 from being partly changed and thus becoming uneven. That is, even if the adhesive 50 made of an ultraviolet-curable resin is cured unevenly due to the black-frame print 41 below the front window 40, the resulting stress can be prevented from affecting the gap between the TFT substrate 10 and the counter substrate 20 of the liquid crystal display panel 200.

A comparison among the counter substrate 20 of the liquid crystal display panel 200, the touch panel 30, and the front window 40 reveals that the front window 40 is the thickest. In the related art, the liquid crystal display panel 200 is bonded to the touch panel 30 bonded with the front window 40. Accordingly, stress resulting from the cure of the adhesive 50 causes distortion in the liquid crystal display panel 200 having lower strength. In the present invention, on the other hand, the liquid crystal display panel 200 and the touch panel 30 are first bonded together and the front window 40 is subsequently bonded to the combination of the touch panel 30 and the liquid crystal display panel 200. At this time, the difference in thickness between the front window 40 and the combination is smaller than that in the related art. This prevents stress caused by the cure of the ultraviolet-curable resin 50 from occurring in the liquid crystal display panel 200 alone. As seen, according to the present invention, it is possible to reduce unevenness of the gap between the TFT substrate 10 and the counter substrate 20 of the liquid crystal display panel 200.

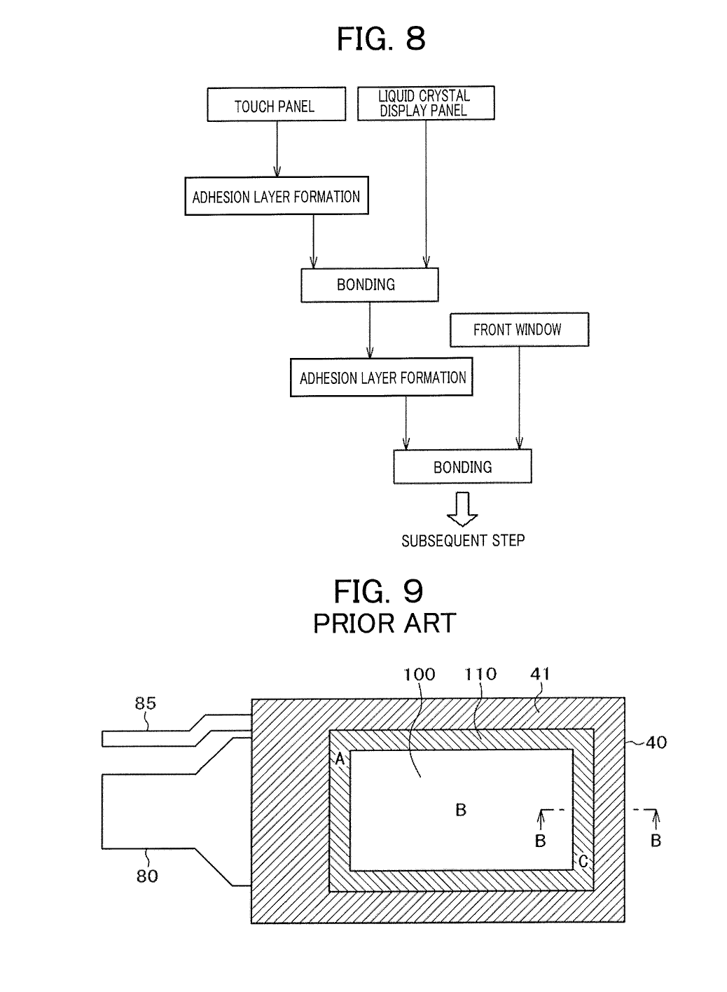

FIG. 8 is a flowchart showing the manufacturing process of the liquid crystal display device according to the present invention described with reference to respect to FIGS. 3 to 7. In FIG. 8, first, the adhesive 50 made of an ultraviolet-curable resin is formed below the touch panel 30. Subsequently, the separately manufactured liquid crystal display panel 200 is bonded to the touch panel 30 using the adhesive 50, and ultraviolet rays are applied to the adhesive 50 from the side adjacent to the touch panel 30. At this time, the ultraviolet rays are applied uniformly. This prevents uneven cure of the adhesive 50, thereby preventing stress caused by the uneven cure from distorting the counter substrate 20 of the liquid crystal display panel 200.

Subsequently, the adhesive 50 made of an ultraviolet-curable resin is formed over the touch panel 30; the separately prepared front window 40 is bonded to the touch panel 30; and ultraviolet rays are applied to the adhesive 50 from the side adjacent to the front window 40. Since the black-frame print 41 is formed around the periphery of the front window 40, the adhesive 50 is cured unevenly. However, this uneven cure has no effect on the counter substrate 20 of the liquid crystal display panel 200.

As described above, the present invention is particularly effectively applied to the liquid crystal display panel 200 which includes a counter substrate 20 having a thickness of 0.2 mm or less and which is formed by injecting liquid crystal by ODF. Further, the present invention is particularly effectively applied to IPS liquid crystal display devices, where the gap between the TFT substrate 10 and the counter substrate 20 is as small as about 4 μm and even slight deformation of the gap causes color irregularities.

As seen above, according to the present invention, it is possible to prevent deformation of the gap between the TFT substrate 10 and the counter substrate 20 of the liquid crystal display panel 200. As a result, it is possible to prevent color irregularities, such as yellowing, around the periphery of the display region 100.

Further, the present invention can be carried out by only changing the order of the process steps of the manufacturing method according to the related art and thus involves no increase in manufacturing cost.

### Second Embodiment

A second embodiment provides a configuration which, when bonding together the liquid crystal display panel 200, the touch panel 30, the front window 40, and the like using transparent adhesive sheets 55, prevents unevenness of the gap between the TFT substrate 10 and the counter substrate 20 of the liquid crystal display panel 200.

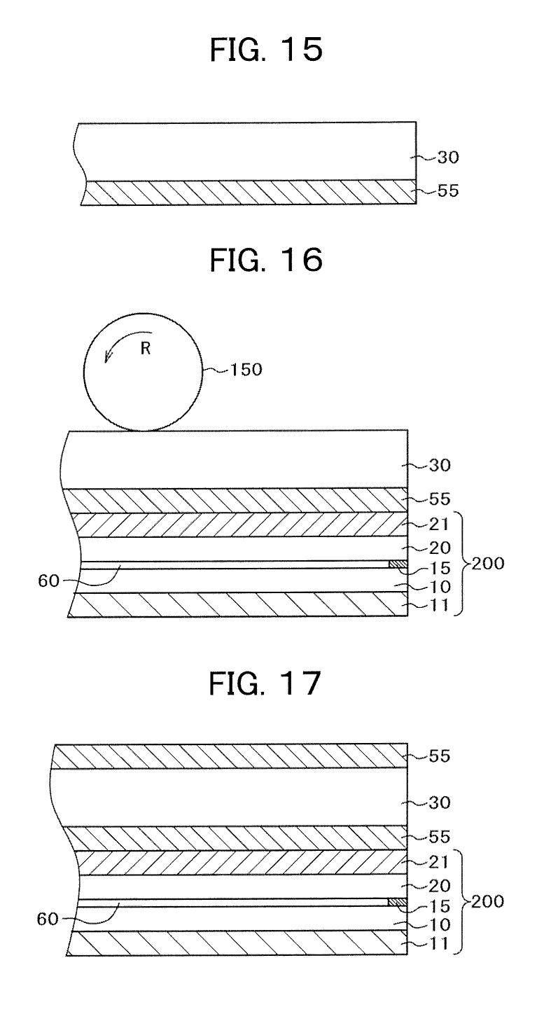

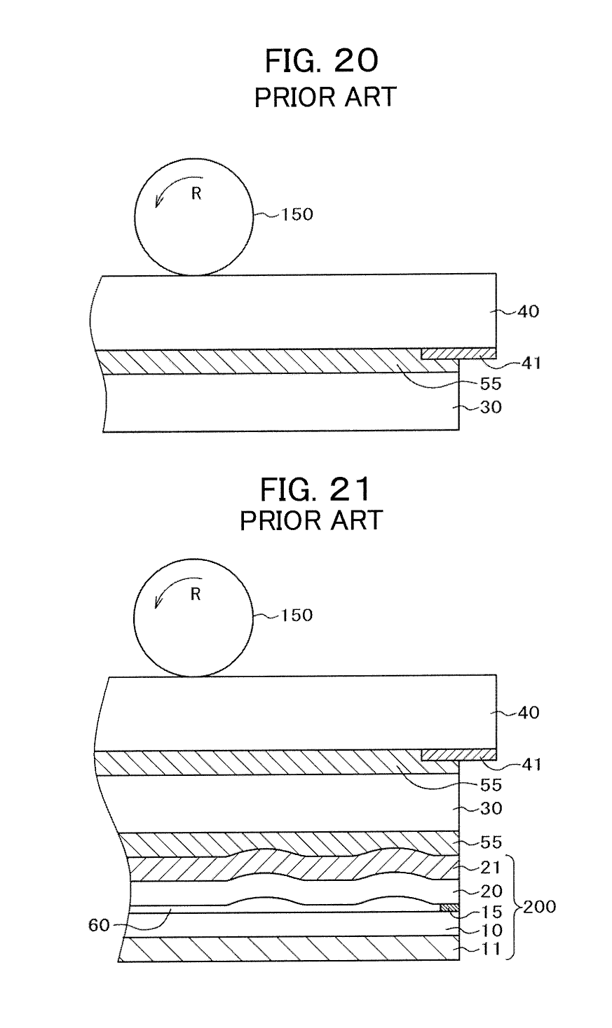

FIGS. 15 to 18 show an example according to the present invention, while FIGS. 19 to 21 show an example according to the related art. Referring first to FIGS. 19 to 21, problems with the related-art example will be described. FIG. 19 shows an example in which the adhesive sheet 55 is bonded to the front window 40 having the black-frame print 41 made thereover. FIG. 20 is a sectional view showing a state in which the front window 40 is being pressed against the touch panel 30 using a roller 150 to bond them together uniformly.

FIG. 21 is a sectional view in which the liquid crystal display panel 200 is bonded to the combination of the front window 40 and the touch panel 30 and in which the combination is being pressed against the liquid crystal display panel 200 using the roller 150. Of the counter substrate 20 of the liquid crystal display panel 200, the touch panel 30, and the front window 40, the front window 40 is the thickest, and the counter substrate 20 is the thinnest.

A comparison in thickness between the combination of the front window 40 and the touch panel 30, and the counter substrate 20 of the liquid crystal display panel 200 reveals that the counter substrate 20 is extremely thin. Accordingly, when pressing the combination against the liquid crystal display panel 200 using the roller 150, stress caused by the press tends to distort the counter substrate 20 of the liquid crystal display panel 200. As a result, the gap between the TFT substrate 10 and the counter substrate 20 tends to become uneven.

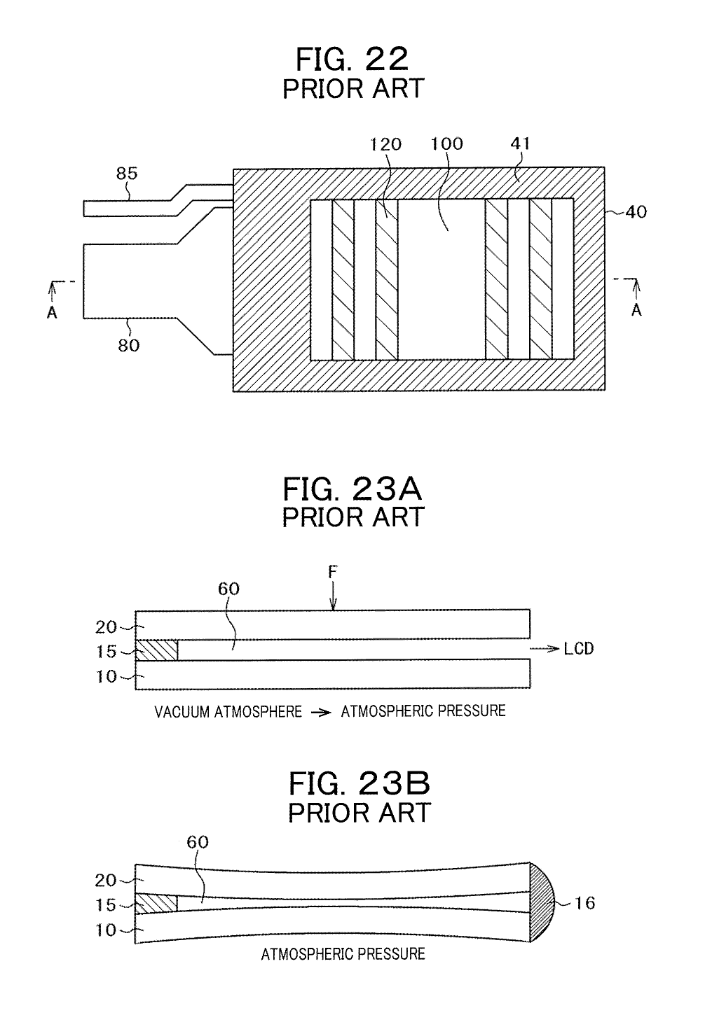

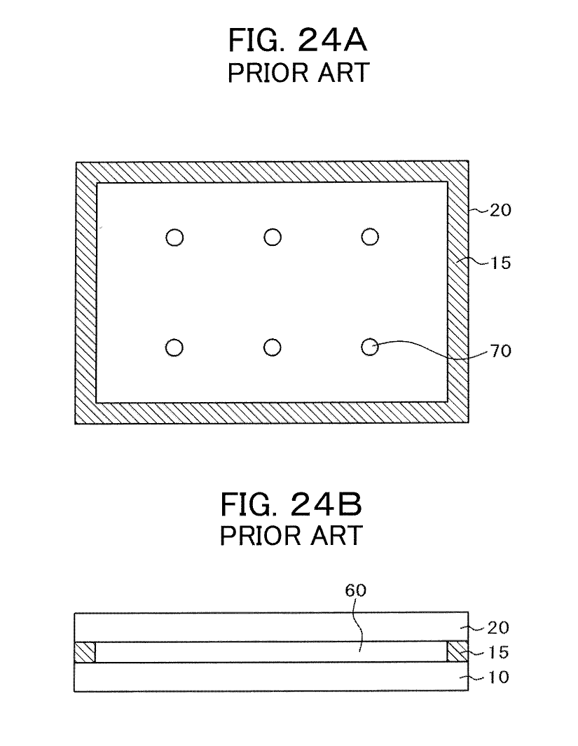

The uneven gap manifests itself in the form of color irregularities as shown in FIG. 22. FIG. 22 shows an example in which banded display irregularities 120 periodically appear in the display region 100 of the liquid crystal display device. The present embodiment copes with the display irregularities 120.

FIGS. 15 to 18 show an example according to the present embodiment. FIG. 15 is a sectional view showing a state in which the adhesive sheet 55 is bonded to one surface of the touch panel 30. FIG. 16 is a sectional view showing a state in which the liquid crystal display panel 200 is bonded to the surface having the adhesive sheet 55 formed therebelow, of the touch panel 30. Examples of the adhesive sheet 55 include optically clear adhesive (OCA) tapes 8146-1, 8146-2, and 8146-3 available from 3M. The touch panel 30 is pressed against the liquid crystal display panel 200 by way of the adhesive sheet 55 using the roller 150 so that these components are bonded together unevenly.

At this time, the respective thicknesses of the liquid crystal display panel 200 and the touch panel 30 do not significantly differ from each other. This prevents stress caused by the press made using the roller 150 from occurring in the liquid crystal display panel 200 alone. Accordingly, the gap between the TFT substrate 10 and the counter substrate 20 of the liquid crystal display panel 200 is less likely to become uneven.

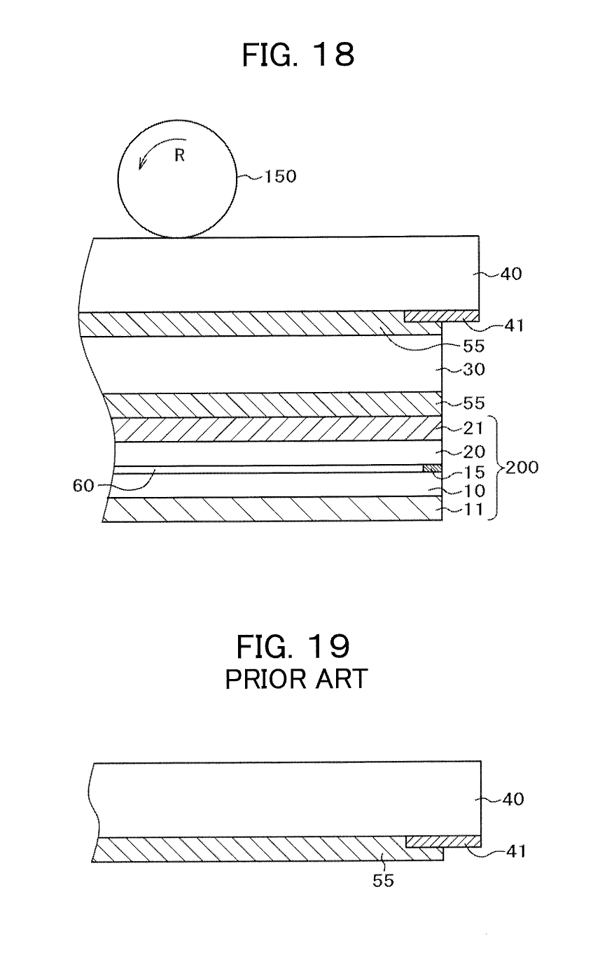

FIG. 17 shows an example in which the adhesive sheet 55 is disposed over the touch panel 30 combined with the liquid crystal display panel 200. FIG. 18 shows an example in which the front window 40 having the black-frame print 41 made around the periphery thereof is bonded to the touch panel 30 combined with the liquid crystal display panel 200. A surface of the front window 40 is pressed against the touch panel 30 using the roller 150 so that these components are uniformly bonded together using the adhesive sheet 55.

Since the front window 40 is bonded to the combination of the liquid crystal display panel 200 and the touch panel 30, the respective thicknesses of the front window 40 and the combination do not significantly differ from each other. This prevents stress caused by the press from distorting only the counter substrate 20 of the liquid crystal display panel 200. As a result, it is possible to suppress unevenness of the gap between the TFT substrate 10 and the counter substrate 20 of the liquid crystal display panel 200.

As seen above, according to the second embodiment, the liquid crystal display panel 200, which is susceptible to the deformation of the gap, is first bonded to the touch panel 30, which does not significantly differ from the liquid crystal display panel 200 in thickness, and subsequently the front window 40, which is the thickest, is bonded to the combination of the liquid crystal display panel 200 and the touch panel 30. Accordingly, the thicknesses can be balanced during the bonding. As a result, it is possible to prevent color irregularities caused by deformation of the gap in the liquid crystal display panel 200.

There has been described an example in which the roller 150 is used in performing bonding using the adhesive sheet 55. Without being limited thereto, the idea that the front window 40, the touch panel 30, and the liquid crystal display panel 200 are bonded together in a manner to balance the respective thicknesses by first bonding the thin touch panel 30 and the liquid crystal display panel 200 together and then bonding the front window 40 to the combination of the touch panel 30 and the liquid crystal display panel 200 are also applicable to other bonding processes, including a process of externally pressing a substrate to be bonded.

What is claimed is:

1. A manufacturing method of a liquid crystal display device, the liquid crystal display device including a liquid crystal display panel having a first substrate and a second substrate, a touch panel, and a third substrate disposed on the touch panel, wherein the first substrate having pixel electrodes and thin-film transistors formed thereover and the second substrate facing the first substrate are bonded together using a sealant; a liquid crystal material is sealed; a lower polarizing plate is bonded to the first substrate; and an upper polarizing plate is bonded to the second substrate, the second substrate is smaller in thickness than the touch panel, and the third substrate is larger in thickness than the touch panel, the method comprising:
dropping the liquid crystal material in an inside area of one of the first and second substrates, the inside area being surrounded with the sealant,
bonding the upper polarizing plate of the liquid crystal display panel and the touch panel together using an ultraviolet-curable resin by applying ultraviolet rays to the ultraviolet curable resin from a side adjacent to the touch panel; and
after the above step, bonding the touch panel and the third substrate together using an ultraviolet-curable resin by applying ultraviolet rays to the ultraviolet curable resin from a side adjacent to the third substrate.

2. The manufacturing method of a liquid crystal display device according to claim 1, wherein the second substrate of the liquid crystal display panel is 0.2 mm or less in thickness.

3. The manufacturing method of a liquid crystal display device according to claim 2, wherein the liquid crystal display panel is an in-plane-switching (IPS) liquid crystal display device.

4. The manufacturing method of a liquid crystal display device according to claim 1, wherein the third substrate covers a main surface of the liquid crystal display panel.

5. The manufacturing method of a liquid crystal display device according to claim 1, wherein a black-frame print is formed on the third substrate,
the black-frame print is disposed at a periphery of the third substrate, and
a display region of the liquid crystal display panel is disposed in an inside area surrounded with the black-frame print.

6. A manufacturing method of a liquid crystal display device, the liquid crystal display device including a liquid crystal display panel having a first substrate and a second substrate, a touch panel, and a third substrate disposed on the touch panel, wherein the first substrate having pixel electrodes and thin-film transistors formed thereover and the second substrate facing the first substrate are bonded together using a sealant; liquid crystal material is sealed; a lower polarizing plate is bonded to the first substrate; and an upper polarizing plate is bonded to the second substrate, the second substrate is smaller in thickness than the touch panel, and the third substrate is larger in thickness than the touch panel, the method comprising:
dropping the liquid crystal material in an inside area of one of the first and second substrates, the inside area being surrounded with the sealant,
bonding the upper polarizing plate of the liquid crystal display panel and the touch panel together using an adhesive sheet; and
after the above step, bonding the touch panel and the third substrate together using an adhesive sheet.

7. The manufacturing method of a liquid crystal display device according to claim 6, wherein the second substrate of the liquid crystal display panel is 0.2 mm or less in thickness.

8. The manufacturing method of a liquid crystal display device according to claim 7, wherein the liquid crystal display panel is an in-plane-switching (IPS) liquid crystal display device.

9. The manufacturing method of a liquid crystal display device according to claim 6, wherein the third substrate covers a main surface of the liquid crystal display panel.

10. The manufacturing method of a liquid crystal display device according to claim 6, wherein a black-frame print is formed on the third substrate,
the black-frame print is disposed at a periphery of the third substrate, and
a display region of the liquid crystal display panel is disposed in an inside area surrounded with the black-frame print.
